(19) United States
(12) Patent Application Publication
(10) Pub. No.: US 2016/0034063 A1
(43) Pub. Date: Feb. 4, 2016

(54) ANTI-INTERFERENCE TOUCH DISPLAY PANEL

(71) Applicants: HannStar Display (Nanjing) Corporation, Nanjing (CN); HANNSTAR DISPLAY CORPORATION, Taipei City (TW)

(72) Inventors: Hsing-Ying LEE, Taipei City (TW); Da-Ching TANG, Taipei City (TW); Tien-Rong LU, Taipei City (TW)

(21) Appl. No.: 14/808,374

(22) Filed: Jul. 24, 2015

(30) Foreign Application Priority Data
Jul. 29, 2014 (CN) 201410365821.5
Jul. 29, 2014 (CN) 201410366322.8
Jul. 29, 2014 (CN) 201410367533.3
Jul. 29, 2014 (CN) 201410367943.8
Jul. 29, 2014 (CN) 201410368046.9

(51) Int. Cl. G06F 3/041

(52) U.S. Cl. CPC G06F 3/041

(57) ABSTRACT

An anti-interference touch display panel comprises a color filter substrate, an active matrix transistor substrate, a display functional layer, a plurality of touch-sensing units and at least one first anti-interference spot. The active matrix transistor substrate is disposed corresponding to the color filter substrate. The display functional layer is disposed between the color filter substrate and the active matrix transistor substrate. The touch-sensing units are coplanarly disposed on the color filter substrate, and a first interval region is formed between the adjacent-touch sensing units. The first anti-interference spot is disposed within the first interval region.

### CROSS REFERENCE TO RELATED APPLICATIONS

This Non-provisional application claims priority under 35 U.S.C. §119(a) on Patent Application No(s). 201410365821.5, 201410367943.8, 201410367533.3, 201410366322.8 and 201410368046.9 filed in People's Republic of China on Jul. 29, 2014, the entire contents of which are hereby incorporated by reference.

### BACKGROUND OF THE INVENTION

1. Field of Invention

This invention relates to a touch display panel and, in particular, to an anti-interference touch display panel.

2. Related Art

Recently, the touch technology has been widely applied to common consumer electronic products, such as liquid crystal display (LCD) panels. The touch technology can be applied to the display panel in multiple types. For example, a touch panel is attached to the display panel, i.e. the out-cell type, or the touch-sensing units are directly formed on the display panel, which is the embedded type and can be divided into the on-cell type and the in-cell type. However, the conventional touch-sensing structures suffer the problem of a decreasing product yield.

A conventional touch-sensing structure comprises a substrate and a plurality of touch-sensing units. The touch-sensing units are disposed on the substrate to sense the user's touch to generate electric signals. After processing the electric signals, the touch coordinates of the user can be obtained. However, because the interval between the touch-sensing units is just 10 μm˜30 μm, the adjacent touch-sensing units will be easily short-circuited when particles fall down or scratches happen during the process, or the touch-sensing units are bent. As a result, the malfunction of the touch product may happen and the product yield will be decreased.

Besides, in order to increase the viewing angle of the display panel, multiple technologies have been presented, such as the multi-domain vertical alignment (MVA) technology and the transverse electric field technology. The fringe field switching (FFS) technology belongs to the field of the transverse electric field technology and becomes one of the potential technologies due to its characteristics of high transmittance, wide viewing angle and low chromatic aberration.

Therefore, it is important to provide an anti-interference touch display panel whereby the above-mentioned short circuit problems can be solved and the touch performance and product yield can be enhanced.

### SUMMARY OF THE INVENTION

An aspect of the invention is to provide an anti-interference touch display panel whereby the above-mentioned short circuit problems can be solved and the touch performance and product yield can be enhanced.

Therefore, an anti-interference touch display panel of this invention comprises a color filter substrate, an active matrix transistor substrate, a display functional layer, a plurality of touch-sensing units and at least one first anti-interference spot. The active matrix transistor substrate is disposed corresponding to the color filter substrate. The display functional layer is disposed between the color filter substrate and the active matrix transistor substrate. The touch-sensing units are coplanarly disposed on the color filter substrate, and a first interval region is formed between the adjacent-touch sensing units. The first anti-interference spot is disposed within the first interval region.

In one embodiment, the anti-interference touch display panel further comprises a grounding unit and at least a second anti-interference spot. The grounding unit is disposed coplanarly with the touch-sensing units. The grounding unit and the adjacent touch-sensing unit have a second interval region therebetween. The second anti-interference spot is disposed within the second interval region.

In one embodiment, the anti-interference touch display panel is a fringe field switching (FFS) liquid crystal touch display panel, the display functional layer is a liquid crystal layer, and the anti-interference touch display panel further comprises a pixel electrode and a common electrode. The pixel electrode and the common electrode are disposed on the active matrix transistor substrate. The rotation of the liquid crystal molecules of the liquid crystal layer is controlled by the fringe field generated between the pixel electrode and the common electrode.

In one embodiment, the active matrix transistor substrate comprises a transparent substrate, a plurality of gate lines, a gate insulating layer and a plurality of data lines. The gate lines are disposed on the transparent substrate. The gate insulating layer is disposed on the transparent substrate and covers the gate lines. The data lines are disposed on the gate insulating layer. The pixel electrode is disposed on the gate insulating layer and located on the same layer as the data lines.

In one embodiment, the active matrix transistor substrate comprises a transparent substrate, a plurality of gate lines, a gate insulating layer and a plurality of data lines. The gate lines are disposed on the transparent substrate. The common electrode is disposed on the transparent substrate and located on the same layer as the gate lines. The gate insulating layer is disposed on the transparent substrate and covers the gate lines and the common electrode. The data lines are disposed on the gate insulating layer and the pixel electrode is disposed on the gate insulating layer.

In one embodiment, the anti-interference touch display panel further comprises at least another touch-sensing unit disposed coplanarly with the common electrode or the pixel electrode.

In one embodiment, the common electrode is a single-piece electrode, and the pixel electrode has a slit pattern formed therein and is disposed over the common electrode, or the pixel electrode is a single-piece electrode, and the common electrode has a slit pattern formed therein and is disposed over the pixel electrode.

In one embodiment, the common electrode comprises multiple strip-like electrodes separated from each other, and the pixel electrode comprises multiple electrodes separated from each other and disposed over the portion between the adjacent strip-like electrodes of the common electrode, or the pixel electrode comprises multiple strip-like electrodes separated from each other, and the common electrode comprises multiple electrodes separated from each other and disposed over the portion between the adjacent strip-like electrodes of the pixel electrode.

In one embodiment, the touch-sensing units are coplanarly disposed on the color filter substrate.

In one embodiment, the anti-interference touch display panel further comprises a polarizing layer and/or a protection glass disposed on the color filter substrate. The touch-sensing units are disposed on the polarizing layer and/or the protection glass.

In one embodiment, the color filter substrate comprises a light-blocking array layer, and the first anti-interference spot and/or the touch-sensing units are disposed corresponding to the light-blocking array layer.

In one embodiment, the color filter substrate comprises a transparent substrate, the touch-sensing units are second touch-sensing units, and the anti-interference touch display panel further comprises a first touch-sensing layer and at least one second touch-sensing layer. The first touch-sensing layer comprises a plurality of first touch-sensing units disposed between the transparent substrate of the color filter substrate and the display functional layer. The second touch-sensing layer comprises the second touch-sensing units disposed on the color filter substrate.

In one embodiment, the anti-interference touch display panel further comprises a grounding unit and at least a second anti-interference spot. The grounding unit is disposed coplanarly with the first or second touch-sensing units, and the grounding unit and the adjacent first or second touch-sensing unit have a second interval region therebetween. The second anti-interference spot is disposed within the second interval region.

In one embodiment, the first touch-sensing layer acts as a light-blocking layer.

In one embodiment, the color filter substrate comprises a light-blocking layer and the first anti-interference spot is disposed corresponding to the light-blocking layer.

In one embodiment, the color filter substrate comprises a transparent substrate, and the touch-sensing units are coplanarly disposed between the transparent substrate of the color filter substrate and the active matrix transistor substrate.

In one embodiment, the anti-interference touch display panel further comprises a shielding layer disposed between the touch-sensing units and the display functional layer.

In one embodiment, the touch-sensing units include a plurality of metal mesh sensing units comprising a plurality of metal wires, and the anti-interference touch display panel further comprises a light-blocking array layer, and the light-blocking array layer is disposed on the metal mesh sensing units and correspondingly covers the metal wires, wherein the light-blocking array layer has at least one opening.

In one embodiment, the metal mesh sensing units comprise a plurality of first metal mesh sensing sub-units, an insulating layer and a plurality of second metal mesh sensing sub-units. The first metal mesh sensing sub-units are disposed on the color filter substrate. The insulating layer is disposed on the first metal mesh sensing sub-units. The second metal mesh sensing sub-units are disposed on the insulating layer.

In one embodiment, the insulating layer possesses the anti-glare ability.

As mentioned above, in the anti-interference touch display panel of this invention, the first anti-interference spot is disposed in the first interval region formed by the adjacent touch-sensing units, and the interval between the touch-sensing units is enlarged thereby, for example, to 70 μm˜130 μm from the original 10μm˜30 μm. Hence, even if the particles fall down or the scratch occurs during the process, the adjacent touch-sensing units won't be short-circuited. Therefore, the first anti-interference spots provide the electrical anti-interference effect, so as to prevent the malfunction of the touch product and enhance the product yield.

Furthermore, the enlarged spacing between the touch-sensing units may make the human eyes perceive the existence of the touch-sensing units, but because the first anti-interference spot with a zigzag pattern is disposed between the adjacent touch-sensing units, the touch-sensing units will become invisible and the human eyes will not easily perceive their existence, so as to provide the optical anti-interference effect and enhance the display performance.

Besides, because the pixel electrode and the data lines are disposed on the gate insulating layer in this invention, the pixel electrode can directly contact the drain instead of through the via for electrically connecting to the drain, and the pixel aperture ratio can be increased thereby. Furthermore, in the design of the common electrode of this invention, the consideration needn't be given to the interval between the common electrode and the gate line, so that the pixel aperture ratio won't be sacrificed.

Furthermore, the first anti-interference spots and/or the touch-sensing units are disposed corresponding to the light-blocking array layer (or the light-blocking layer), and for example, the light-blocking array layer is disposed corresponding to the first anti-interference spots. Thereby, the light-blocking array layer can not only define the position of the pixel but also block the light passing through the first anti-interference spots, so as to enhance the display performance.

In addition, this invention also discloses the replacement or sharing of some layers of the anti-interference touch display panel for the touch-sensing units. For example, the first conducting wire can act as the light-blocking layer or the first touch-sensing layer acts as the light-blocking layer. Thereby, the anti-interference touch display panel can be given the effects of decreasing the cost and the thickness.

Moreover, the shielding layer is disposed between the touch-sensing units and the display functional layer (e.g. liquid crystal layer) to prevent the electric field within the liquid crystal layer from affecting the touch-sensing units.

Besides, because the light-blocking array layer matches the metal mesh sensing units in shape and covers the metal mesh sensing units in this invention, the Moire phenomenon can be reduced.

In addition, the insulating layer of this invention possesses the anti-glare ability so that is can absorb and filter the external incident light. Thereby, the reflection and interference generated between the external incident light and the metal mesh can be reduced, the brightness contrast of the display panel can be enhanced, and the anti-glare effect can be provided against the external incident light.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of an anti-interference touch display panel of an embodiment of the invention;

FIG. 2 is a schematic diagram of an anti-interference touch display panel of another embodiment of the invention;

FIG. 3 is a schematic diagram of an anti-interference touch display panel of another embodiment of the invention;

FIG. 4 is a schematic diagram of an anti-interference touch display panel of another embodiment of the invention;

FIGS. 5A to 5C are schematic top views of the anti-interference touch display panels of different embodiments of the invention;

FIG. 6A is a schematic diagram of the layout of the active matrix transistor substrate of an embodiment of the invention;

FIG. 6B is a schematic sectional diagram of the active matrix transistor substrate of FIG. 6A taken along the line A-A;

FIG. 7A is a schematic diagram of the layout of the active matrix transistor substrate of an embodiment of the invention;

FIG. 7B is a schematic sectional diagram of the active matrix transistor substrate of FIG. 7A taken along the line B-B;

FIGS. 8 to 10 are schematic diagrams of the anti-interference touch display panels of different embodiments of the invention;

FIG. 11 is a schematic top view of the touch-sensing units of an embodiment of the invention;

FIGS. 12A to 12D are schematic diagrams showing different embodiments of the touch-sensing units of FIG. 11;

FIGS. 13 to 17 are schematic diagrams of the anti-interference touch display panels of different embodiments of the invention;

FIGS. 18 to 24 are schematic diagrams of the anti-interference touch display panels of different embodiments of the invention;

FIG. 25 is a schematic sectional diagram of an anti-interference touch-sensing stack of an embodiment of the invention; and

FIGS. 26 to 29 are schematic diagrams of the anti-interference touch-sensing stacks of different embodiments of the invention.

### DETAILED DESCRIPTION OF THE INVENTION

The present invention will be apparent from the following detailed description, which proceeds with reference to the accompanying drawings, wherein the same references relate to the same elements.

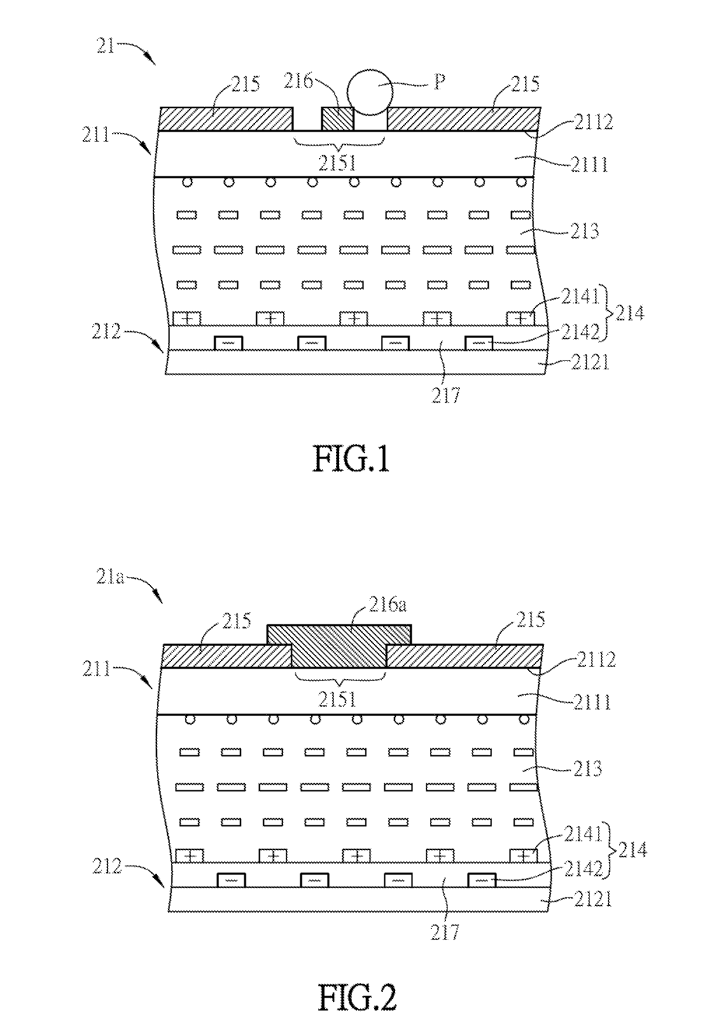

FIG. 1 is a schematic diagram of an anti-interference touch display panel 21 of an embodiment of the invention, and the anti-interference touch display panel 21 of this embodiment is illustrated as a FFS liquid crystal touch display panel for example. As shown in FIG. 1, the anti-interference touch display panel 21 comprises a color filter substrate 211, an active matrix transistor substrate 212, a display functional layer 213, an electrode pair 214, a plurality of touch-sensing units 215 and at least one anti-interference spot 216.

The color filter substrate 211 comprises a transparent substrate 2111, and can further comprise a color filter layer, or a black matrix layer, or an alignment layer, or a polarizing layer or other functional layers. Since the conventional art can be applied to the above-mentioned elements, the related illustrations are omitted here for conciseness. Moreover, the structure of the above-mentioned color filter substrate 211 is just for example but not for limiting the scope of the invention. In addition, because the FFS technology is used in this embodiment, the common electrode is disposed on the active matrix transistor substrate 212.

The active matrix transistor substrate 212 is disposed corresponding to the color filter substrate 211. The active matrix transistor substrate 212 can comprise a transparent substrate 2121 and can further comprise transistors, or data lines, or scan lines, or an alignment layer, or a polarizing layer or other elements or functional layers. Since the conventional art can be applied to the above-mentioned elements, the related illustrations are omitted here for conciseness. Moreover, the structure of the above-mentioned active matrix transistor substrate 212 is just for example but not for limiting the scope of the invention.

In this embodiment, the display functional layer 213 is illustrated as a liquid crystal layer for example. The display functional layer 213 is disposed between the color filter substrate 211 and the active matrix transistor substrate 212, and the rotation of the liquid crystal molecules of the display functional layer 213 is controlled by the fringe field generated by the electrode pair 214. The electrode pair 214 is disposed on the active matrix transistor substrate 212 and comprises a pixel electrode 2141 and a common electrode 2142. Herein, the electrode pair 214 is disposed on the side of the transparent substrate 2121 facing the display functional layer 213. The common electrode 2142 comprises multiple strip-like electrodes separated from each other, and the pixel electrode 2141 comprises multiple electrodes separated from each other and disposed over the portion between the adjacent strip-like electrodes of the common electrode 2142. In other embodiments, the pixel electrode 2141 and the common electrode 2142 can be exchanged in position, and that is, the pixel electrode 2141 comprises multiple strip-like electrodes separated from each other, and the common electrode 2142 comprises multiple electrodes separated from each other and disposed over the portion between the adjacent strip-like electrodes of the pixel electrode 2141. By the alternate arrangement of the pixel electrode 2141 and the common electrode 2142, the fringe field can be generated to control the rotation of the liquid crystal molecules. The materials of the pixel electrode 2141 and the common electrode 2142 are metal oxide for example, such as ITO (indium tin oxide) or IZO (indium zinc oxide). Moreover, an insulating layer 217 is disposed between the pixel electrode 2141 and the common electrode 2142 to electrically isolate the pixel electrode 2141 from the common electrode 2142.

The touch-sensing units 215 are coplanarly disposed on the color filter substrate 211. Herein, the touch-sensing units 215 are disposed on the side of the color filter substrate 211 opposite to the display functional layer 213. In other embodiments, the touch-sensing units 215 may be disposed on the side of the color filter substrate 211 facing the display functional layer 213. The touch-sensing units 215 are disposed, for example, on a surface 2112 of the transparent substrate 2111 to achieve the coplanar disposition. A first interval region 2151 is formed between the adjacent touch-sensing units 215. The touch-sensing units 215 can be made of transparent conducting materials, such as ITO or other metal oxides. The two touch-sensing units 215 shown in FIG. 1 are electrically insulated from each other for example. Moreover, a protection layer (not shown) can be disposed on the touch-sensing units 215 to cover the touch-sensing units 215.

The first anti-interference spot 216 is disposed within the first interval region 2151. In practice, the first anti-interference spot 216 and the touch-sensing units 215 can be formed in the same process step and made of the same material to reduce the processing steps. However, this invention is not limited thereto. Herein, the first anti-interference spot 216 is made of conducting material and is electrically floating, and a distance exists between the first anti-interference spot 216 and the adjacent touch-sensing unit 215. By disposing the first anti-interference spot 216 within the first interval region 2151, the interval between the adjacent touch-sensing units 215 (first interval region 2151) can be enlarged. Therefore, even if the particles P fall down or the scratch occurs, the adjacent touch-sensing units 215 won't be short-circuited, so as to prevent the malfunction of the touch product and enhance the product yield. The above-mentioned particles P come from, for example, the subsequent process which can at least comprise a mechanical thinning process, a chemical thinning process, a chemical-mechanical thinning process, a photolithography process, a thin film deposition process and/or a thin film etching process. By disposing the first anti-interference spot 216 within the first interval region 2151 formed by the adjacent touch-sensing units 215, the interval between the adjacent touch-sensing units 215 can be enlarged. Thereby, the short circuit won't be caused even if the particle pollution of the subsequent process occurs, so as to provide the electrical anti-interference effect.

Besides, the enlarged spacing between the touch-sensing units 215 may make the human eyes perceive the existence of the touch-sensing units 215, but because the first anti-interference spot 216 is disposed between the adjacent touch-sensing units 215, the human eyes will not easily perceive the existence of the touch-sensing units 215 and therefore the display performance will not be degraded. For example, the width of the first anti-interference spot 216 is between 50 μm and 70 μm, and the width of the first interval region 2151 is between 70 μm and 130 μm. In one embodiment, the material of the first anti-interference spot 216 can comprise metal oxide. Moreover, the first anti-interference spots 216 can comprise a massive spot or a bent spot. The first anti-interference spot 216 can exhibit a bent pattern.

FIG. 2 is a schematic diagram of the anti-interference touch display panel 21a of another embodiment of the invention. As shown in FIG. 2, the main difference between the anti-interference touch display panels 21 and 21a is that the first anti-interference spot 216a of the anti-interference touch display panel 21a not only is disposed in the first interval region 2151 but also covers at least a part of the touch-sensing units 215, and is filled into the first interval region 2151. Herein, the first anti-interference spot 216a is made of insulating material such that the touch-sensing units 215 won't be short-circuited. The first anti-interference spot 216a can be made of transparent material so as to be pervious to the light.

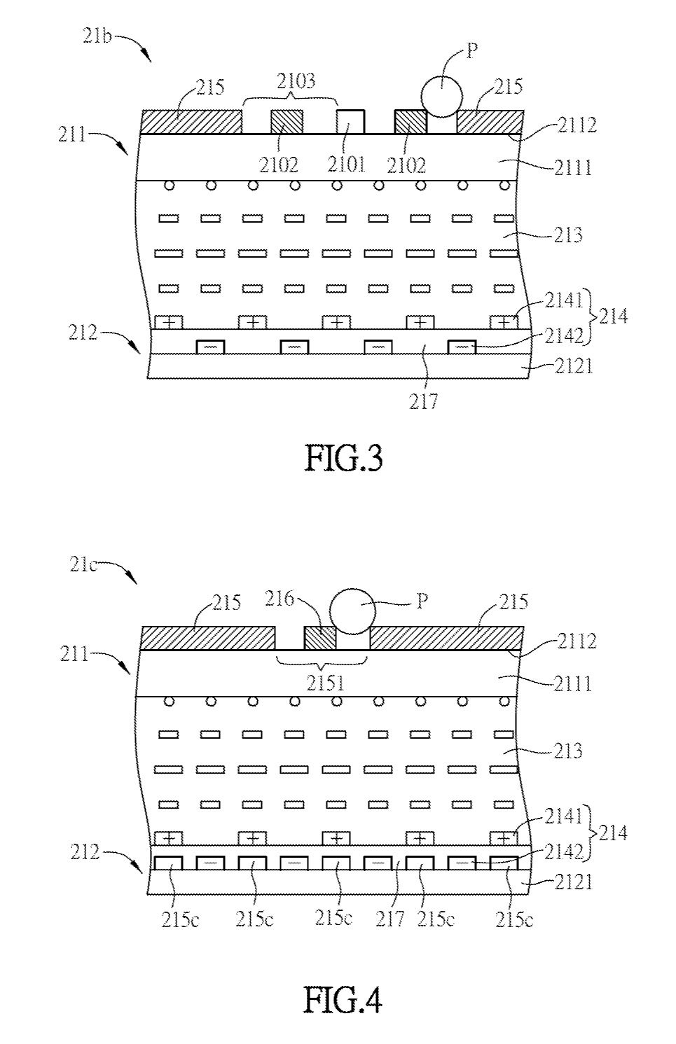

FIG. 3 is a schematic diagram of the anti-interference touch display panel 21b of another embodiment of the invention. As shown in FIG. 3, the main difference between the anti-interference touch display panels 21 and 21b is that the anti-interference touch display panel 21b further comprises a grounding unit 2101 and at least a second anti-interference spot 2102. The grounding unit 2101 is disposed coplanarly with the touch-sensing units 215, and the grounding unit 2101 and the adjacent touch-sensing unit 215 have a second interval region 2103 therebetween. Besides, the second anti-interference spot 2102 is disposed within the second interval region 2103. Likewise, in practice, the second anti-interference spot 2102 and the touch-sensing units 215 can be made in the same processing step and made of the same material to reduce the processing steps. However, this invention is not limited thereto. Herein, the second anti-interference spot 2102 is made of conducting material and is electrically floating. By disposing the second anti-interference spot 2102 within the second interval region 2103, the interval between the touch-sensing unit 215 and the grounding unit 2101 (second interval region 2103) can be enlarged. Therefore, even if the particles P fall down or the scratch occurs, the touch-sensing unit 215 and the adjacent grounding unit 2101 won't be short-circuited, so as to prevent the malfunction of the touch product and enhance the product yield. The width of the second anti-interference spot 2102 is, for example, between 50 μm and 70 μm, and the width of the second interval region 2103 is, for example, between 70 μm and 130 μm.

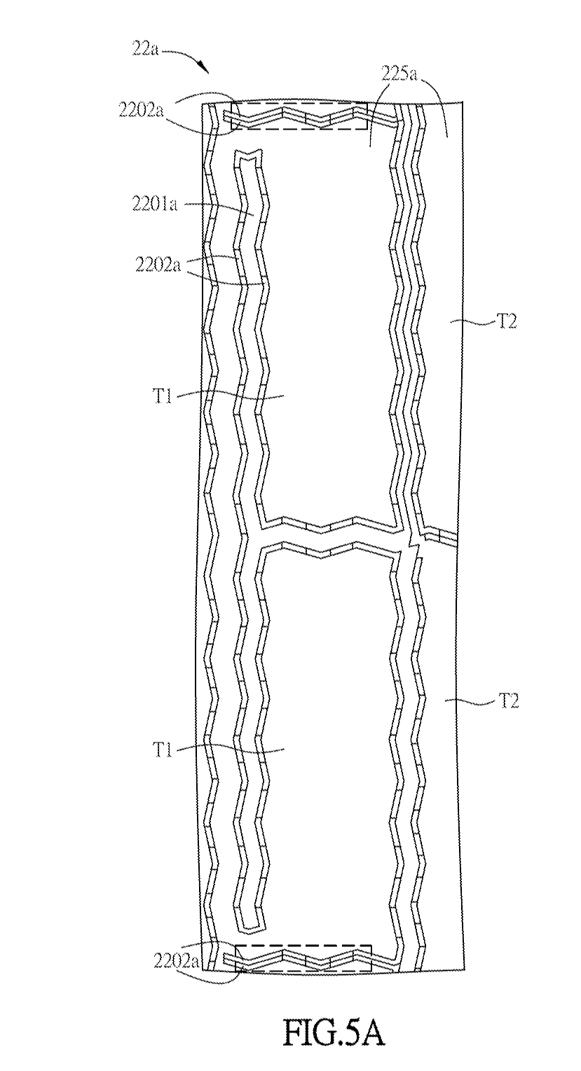

FIG. 4 is a schematic diagram of the anti-interference touch display panel 21c of another embodiment of the invention. As shown in FIG. 4, the anti-interference touch display panel 21c can further comprise at least another touch-sensing unit 215c, and the touch-sensing unit 215c can be coplanarly disposed with the common electrode 2142 or the pixel electrode 2141, or can be disposed above or below the common electrode 2142 or the pixel electrode 2141. Herein, the touch-sensing unit 215c is coplanarly disposed with the common electrode 2142 for example. Therefore, a capacitance can be formed between the touch-sensing unit 215c and the common electrode 2142, and the touch sensing can be implemented according to the capacitance change caused by the user's touch.

To be noted, the technical features as mentioned above can be implemented separately or in combination.

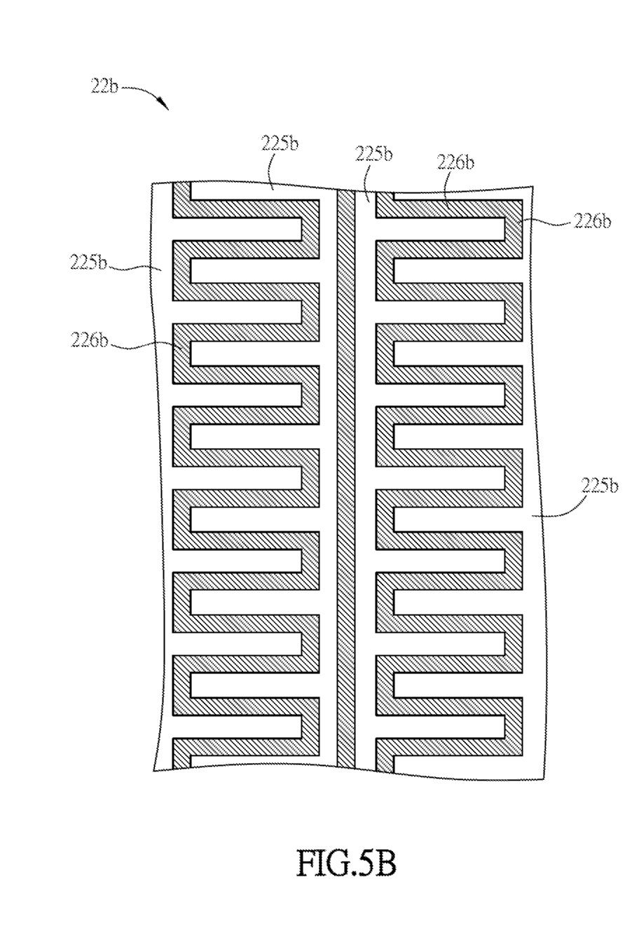

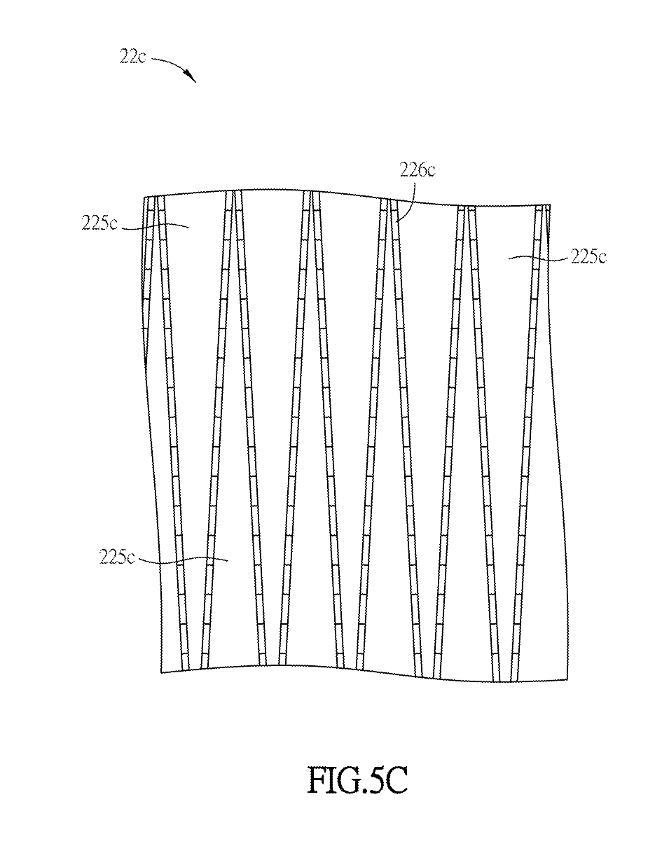

In a top view, the shapes of the touch-sensing unit, the first anti-interference spot, the grounding unit and the second anti-interference spot are not limited, which can be, for example, a curved shape, a triangle, a quadrangle (such as a rhombus), another polygon or a combination thereof. Herein, some examples are illustrated in FIGS. 5A to 5C.

FIG. 5A is a schematic top view of an anti-interference touch display panel 22a of an embodiment of the invention. For the convenient illustration, FIG. 5A just shows the touch-sensing unit 225a, the second anti-interference spot 2202a and the grounding unit 2201a. The touch-sensing unit 225a has a quadrangle-like shape. The grounding unit 2201a is disposed around the touch-sensing unit 225a and, for example, between the adjacent touch-sensing units 225a. Moreover, the anti-interference spot (the second anti-interference spot 2202a for example) is disposed within the second interval region formed by the grounding unit 2201a and the touch-sensing unit 225a. Herein, the second anti-interference spot 2202a is disposed on at least one side of the touch-sensing unit 225a or around the whole touch-sensing unit 225a.

Moreover, in this embodiment, the first anti-interference spots or the second anti-interference spots can be disposed adjacent to each other. For example, the dotted block in FIG. 5A shows two second anti-interference spots 2202a disposed adjacent to each other. Therefore, the width of the two adjacent second anti-interference spots 2202a can be between 100 μm and 140 μm, and the width of the second interval region can be between 120 μm and 200 μm. The same disposition also can be applied to the first anti-interference spot, and the related description is omitted here for conciseness.

Furthermore, the touch-sensing units 225a can comprise a plurality of first touch-sensing elements T1 and a plurality of second touch-sensing elements T2. The first touch-sensing elements T1 serve as the transmitters and the second touch-sensing elements T2 serve as the receivers. The transmitters are coupled with an excitation signal (not shown). When the user touches, the capacitance between the first touch-sensing element T1 and the second touch-sensing element T2 will be changed so that the touch coordinates can be obtained.

In other embodiments, the touch-sensing units 225a can comprise a plurality of first touch-sensing elements electrically connected with each other along a first direction and a plurality of second touch-sensing elements electrically connected with each other along a second direction. For example, the first direction is X direction and the second direction is Y direction. Thereby, the touch coordinates of the user can be obtained after the signal process. Since the conventional art can be applied thereto, the related description is omitted here for conciseness.

Moreover, in other embodiments, a capacitance can be formed between the touch-sensing unit 225a and the common electrode, so that the touch sensing can be implemented according to the capacitance change caused by the user's touch.

FIG. 5B is a schematic top view of an anti-interference touch display panel 22b of an embodiment of the invention. For the convenient illustration, FIG. 5B just shows the touch-sensing unit 225b and the first anti-interference spot 226b. The touch-sensing unit 225b has a bent shape. Moreover, the anti-interference spot (the first anti-interference spot 226b for example) is disposed within the first interval region formed by the adjacent touch-sensing units 225b. Herein, the first anti-interference spot 226b exhibits a zigzag pattern and is disposed on at least one side of the touch-sensing unit 225b or around the whole touch-sensing unit 225b.

FIG. 5C is a schematic top view of an anti-interference touch display panel 22c of an embodiment of the invention. For the convenient illustration, FIG. 5C just shows the touch-sensing unit 225c and the first anti-interference spot 226c. The touch-sensing unit 225c has a triangular shape and the touch-sensing units 225c are disposed side by side. Moreover, the anti-interference spot (the first anti-interference spot 226c for example) is disposed within the first interval region formed by the adjacent touch-sensing units 225c. Herein, the first anti-interference spot 226c has a strip-like shape and is disposed on at least one side of the touch-sensing unit 225c or around the whole touch-sensing unit 225c.

Moreover, the touch-sensing units of this invention can be applied to other aspects, such as the metal mesh technology. Accordingly, the touch-sensing units can be the metal-made touch-sensing wires, so that they can reduce the signal attenuation problem occurring in the design of a large-size ITO by their own conducting property of the metal material. Besides, the metal material has better flexibility than ITO so that it can be applied to a flexible touch panel.

The active matrix transistor substrate of the anti-interference touch display panel of this invention can have multiple variations, some of which are illustrated as below for example.

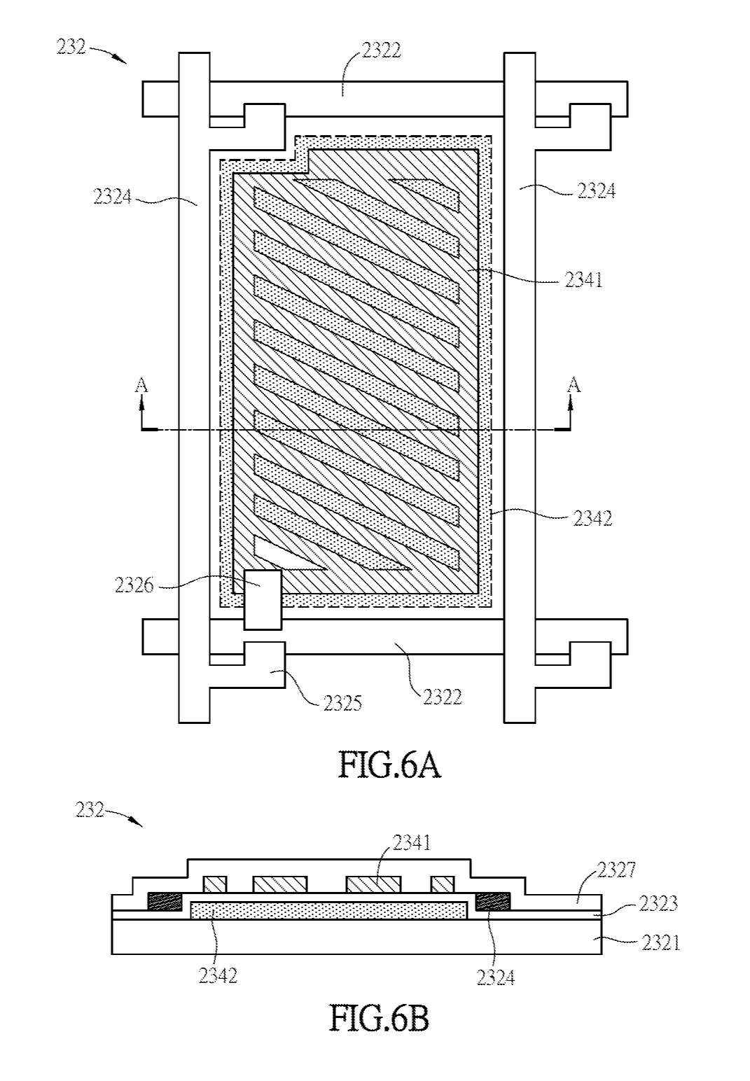

FIG. 6A is a schematic diagram of the layout of the active matrix transistor substrate 232 of an embodiment of the invention, and FIG. 6B is a schematic sectional diagram of the active matrix transistor substrate 232 of FIG. 6A taken along the line A-A. As shown in FIGS. 6A and 6B, a plurality of gate lines 2322 are disposed on a transparent substrate 2321 (such as a glass substrate). A plurality of common electrodes 2342 are disposed on the transparent substrate 2321 and located on the same layer as the gate lines 2322. A gate insulating layer 2323 is disposed on the transparent substrate 2321 and covers the gate lines 2322 and the common electrodes 2342. A plurality of data lines 2324, sources 2325 and drains 2326 are disposed on the gate insulating layer 2323. A plurality of pixel electrodes 2341 are also disposed on the gate insulating layer 2323. The pixel electrodes 2341 and the data lines 2324 are disposed on the gate insulating layer 2323, so that the pixel electrodes 2341 can directly contact the drains 2326. The pixel electrodes 2341 and the common electrodes 2342 can be regarded as the top electrodes and the bottom electrodes respectively, so as to form a transverse electric field, which can control the rotation of the liquid crystal molecules in the liquid crystal layer. A protection layer 2327 is disposed on the gate insulating layer 2323 and covers the data lines 2324, the sources 2325, the drains 2326 and the pixel electrodes 2341. Moreover, as shown in FIGS. 6A and 6B, in this embodiment, the common electrode 2342 is a single-piece electrode, and the pixel electrode 2341 having a slit pattern formed therein is disposed over the common electrode 2342.

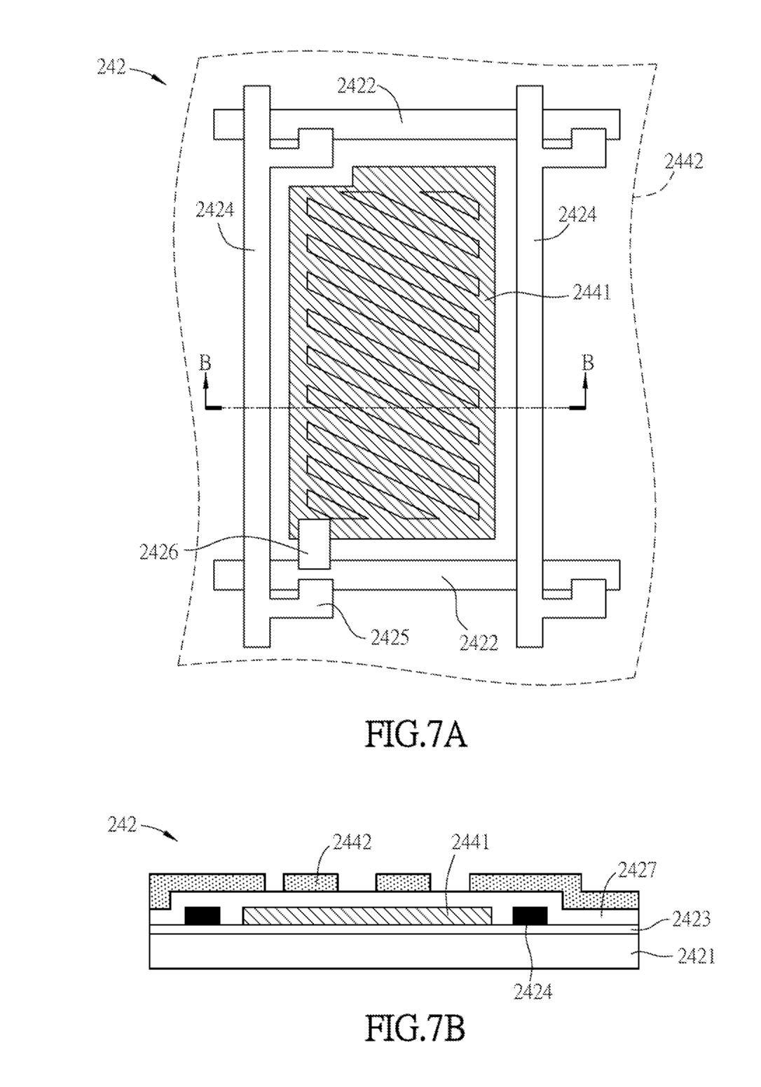

FIG. 7A is a schematic diagram of the layout of the active matrix transistor substrate 242 of an embodiment of the invention, and FIG. 7B is a schematic sectional diagram of the active matrix transistor substrate 242 of FIG. 7A taken along the line B-B. As shown in FIGS. 7A and 7B, a plurality of gate lines 2422 are disposed on a transparent substrate 2421 (such as a glass substrate). A gate insulating layer 2423 is disposed on the transparent substrate 2421 and covers the gate lines 2422. A plurality of data lines 2424, sources 2425 and drains 2426 are disposed on the gate insulating layer 2423. A plurality of pixel electrodes 2441 are also disposed on the gate insulating layer 2423 and located on the same layer as the data lines 2424. The pixel electrodes 2441 can directly contact the drains 2426. A protection layer 2427 is disposed on the gate insulating layer 2423 and covers the data lines 2424, the sources 2425, the drains 2426 and the pixel electrodes 2441. A common electrode 2442 is disposed on the protection layer 2427. Moreover, as shown in FIGS. 7A and 7B, in this embodiment, the pixel electrode 2441 is a single-piece electrode, and the common electrode 2442 having a slit pattern formed therein is disposed over the pixel electrode 2441.

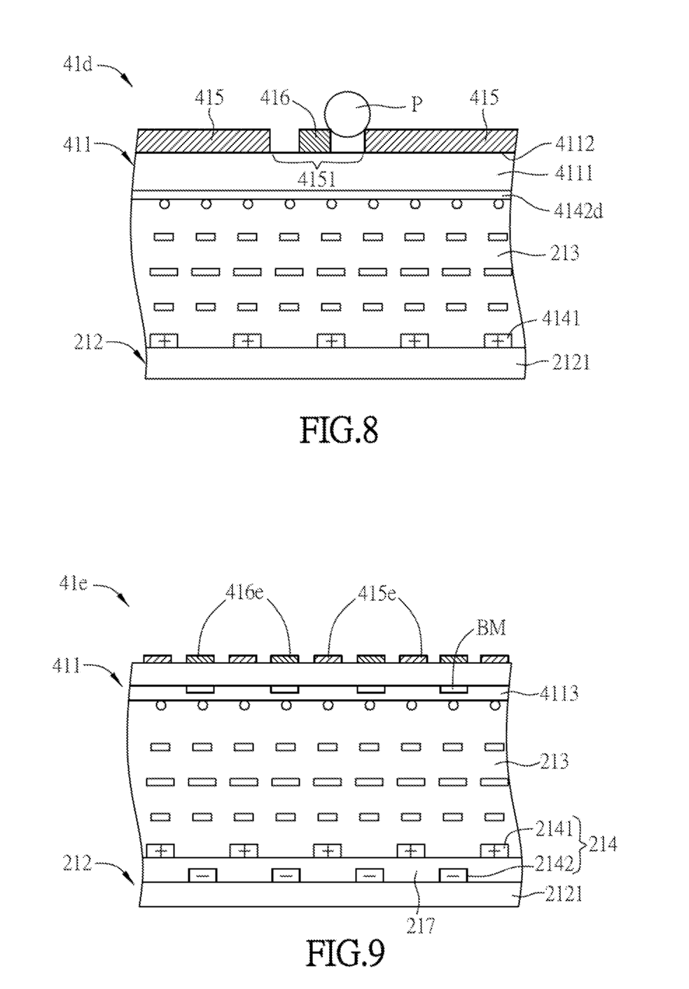

FIG. 8 is a schematic diagram of the anti-interference touch display panel 41d of another embodiment of the invention. As shown in FIG. 8, the main difference from the above embodiment is that the anti-interference touch display panel 41d is not a FFS display panel, and the common electrode 4142d thereof is disposed on the color filter substrate 411, for example, on the side of the transparent substrate 4111 closer to the liquid crystal, so that the liquid crystal of the display functional layer 213 can be driven by the electric field formed by the common electrode 4142d and the pixel electrode 4141.

FIG. 9 is a schematic diagram of the anti-interference touch display panel 41e of another embodiment of the invention. As shown in FIG. 9, the color filter substrate 411 of the anti-interference touch display panel 41e further comprises a light-blocking array layer BM, and the first anti-interference spot 416e is disposed corresponding to the light-blocking array layer BM. Herein, the light-blocking array layer BM overlaps the first anti-interference spot 416e. Thereby, the light-blocking array layer BM can not only define the position of the pixel but also block the light passing through the first anti-interference spot 416e, so as to enhance the display performance. Besides, the light-blocking array layer BM also can be disposed corresponding to the touch-sensing unit 415e or corresponding to the touch-sensing unit 415e and the first anti-interference spot 416e. In addition, the color filter substrate 411 further comprises an overcoat layer 4113 covering the light-blocking array layer BM.

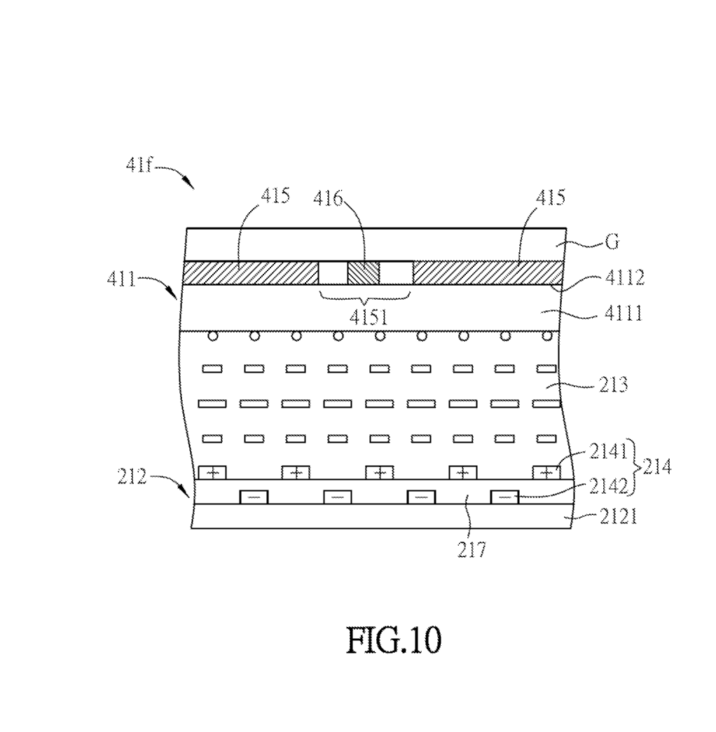

FIG. 10 is a schematic diagram of the anti-interference touch display panel 41f of another embodiment of the invention, and the anti-interference touch display panel 41f is formed according to the OGS (one glass solution) technology. As shown in FIG. 10, the anti-interference touch display panel 41f further comprises a protection glass G disposed on the color filter substrate 411. The touch-sensing units 415 are disposed on the protection glass G. In other embodiments, the protection glass G can be replaced by a polarizing layer, or the protection glass G is configured with the polarizing layer and then configured with the touch-sensing unit 415, or the protection glass G is configured with the touch-sensing unit 415 and then configured with the polarizing layer. By the OGS technology, the anti-interference touch display panel of this embodiment can be decreased in thickness.

The touch-sensing units of the anti-interference touch display panel of this invention can have multiple variations, some of which are illustrated as below for example.

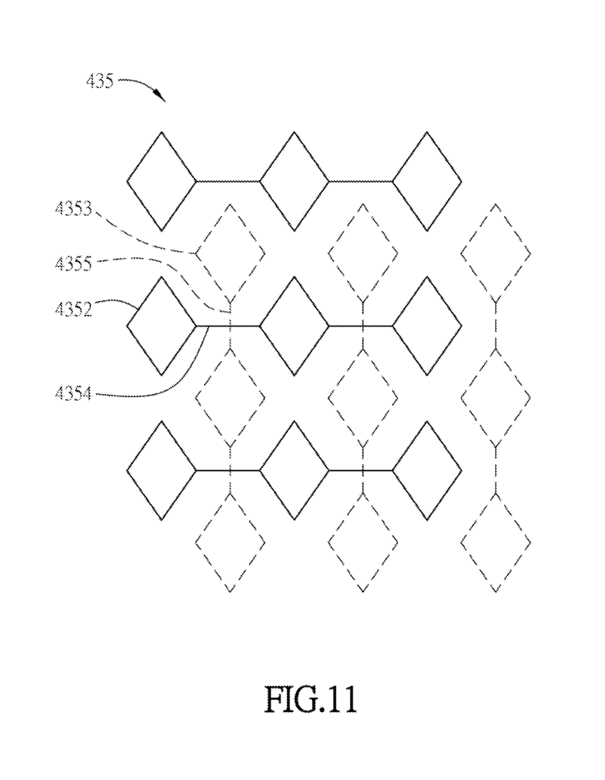

FIG. 11 is a schematic top view of the touch-sensing units of an embodiment of the invention. As shown in FIG. 11, the touch-sensing units 435 comprise a plurality of first touch-sensing elements 4352 electrically connected with each other along a first direction and a plurality of second touch-sensing elements 4353 electrically connected with each other along a second direction. Herein, the first direction is perpendicular to the second direction for example. Moreover, the first touch-sensing elements 4352 and the second touch-sensing elements 4353 can be located on the same or different layers. A first conducting wire 4354 connects to the adjacent first touch-sensing elements 4352, a second conducting wire 4355 connects to the adjacent second touch-sensing elements 4353, and the first conducting wire 4354 and the second conducting wire 4355 are electrically insulated from each other. By the first touch-sensing elements 4352 disposed along the first direction and the second touch-sensing elements 4353 disposed along the second direction, the X and Y coordinates of the touch point can be detected.

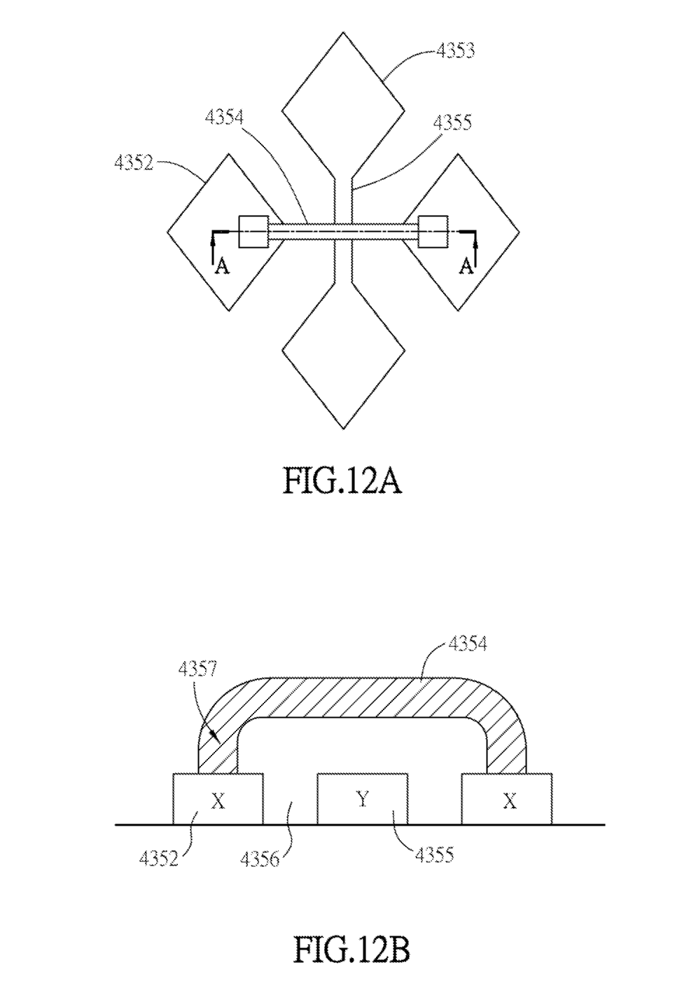

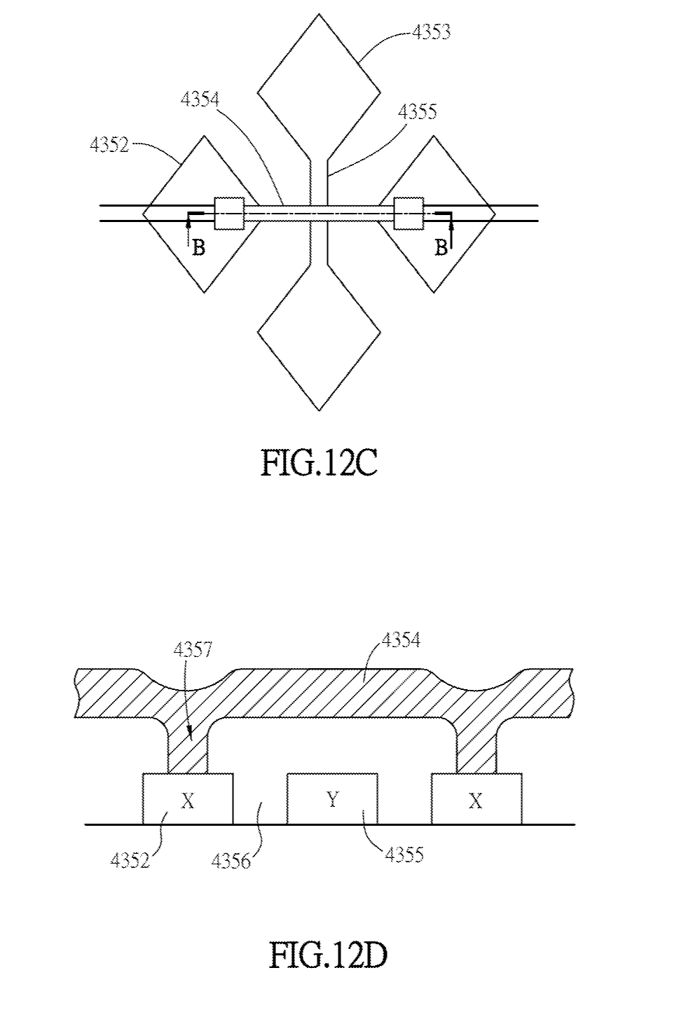

FIGS. 12A and 12B are schematic diagrams showing an embodiment of the touch-sensing units of FIG. 11, and FIG. 12B is a schematic sectional diagram of FIG. 12A taken along the line A-A. As shown in FIGS. 12A and 12B, the first touch-sensing elements 4352 and the second touch-sensing elements 4353 are located on the same layer, and the first conducting wire 4354 and the second conducting wire 4355 are electrically insulated from each other by an insulating layer 4356. The insulating layer 4356 comprises a conducting hole 4357 at the first touch-sensing element 4352, and the first conducting wire 4354 is electrically connected with the first touch-sensing element 4352 through the conducting hole 4357.

FIGS. 12C and 12D are schematic diagrams showing another embodiment of the touch-sensing units of FIG. 11, and FIG. 12D is a schematic sectional diagram of FIG. 12C taken along the line B-B. As shown in FIGS. 12C and 12D, the first conducting wire 4354 of the first direction is a continuous straight line connecting to the first touch-sensing elements 4352 of the same row along the first direction.

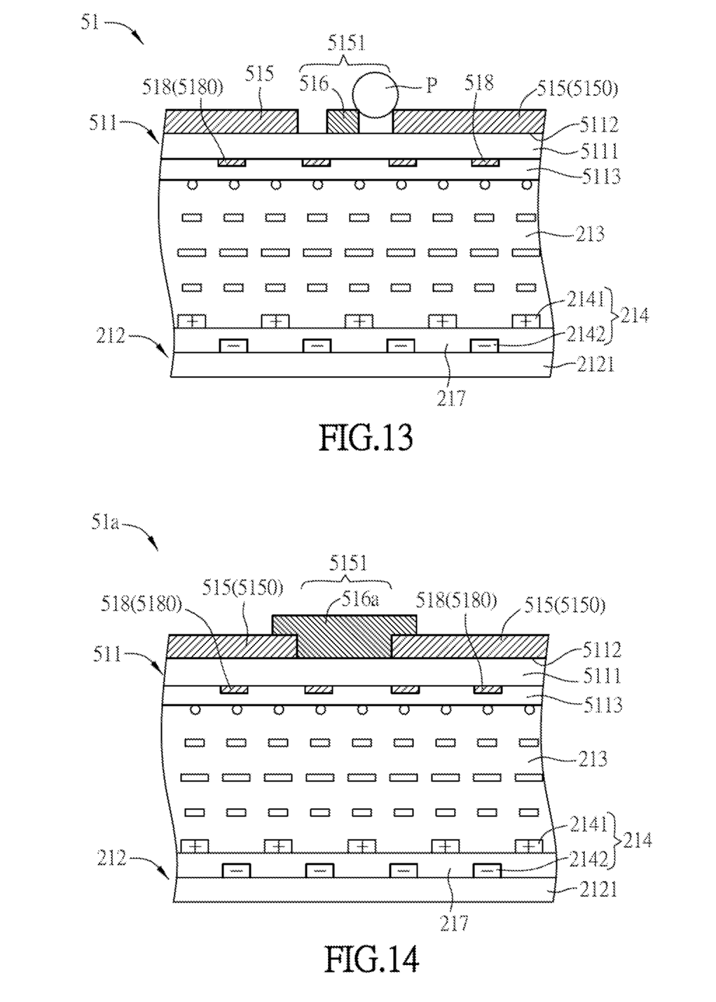

FIG. 13 is a schematic diagram of the anti-interference touch display panel 51 of an embodiment of the invention. As shown in FIG. 13, the anti-interference touch display panel 51 comprises a color filter substrate 511, an active matrix transistor substrate 212, a display functional layer 213, an electrode pair 214, a first touch-sensing layer 518, at least one second touch-sensing layer 515 and at least one anti-interference spot 516. The anti-interference touch display panel 51 of this embodiment can be, for example, a TN (twisted nematic), VA (vertical alignment), IPS (in-plane switching) or FFS liquid crystal touch display panel, or an organic light-emitting touch display panel. Herein, the anti-interference touch display panel 51 is illustrated as a FFS liquid crystal touch display panel for example.

The color filter substrate 511 comprises a transparent substrate 5111, and can further comprise a color filter layer, or a black matrix layer, or an alignment layer, or a polarizing layer or other functional layers. Since the conventional art can be applied to the above-mentioned elements, the related illustrations are omitted here for conciseness. Moreover, the structure of the above-mentioned color filter substrate 511 is just for example but not for limiting the scope of the invention. In addition, because the FFS technology is used in this embodiment, the common electrode 2142 is disposed on the active matrix transistor substrate 212.

The first touch-sensing layer 518 comprises a plurality of first touch-sensing units 5180 disposed between the transparent substrate 5111 of the color filter substrate 511 and the display functional layer 213. Herein, the first touch-sensing units 5180 are disposed on the side of the transparent substrate 5111 facing the display functional layer 213, but this doesn't mean that the first touch-sensing units 5180 must be disposed on a surface of the transparent substrate 5111. The first touch-sensing units 5180 are disposed coplanarly in this embodiment, but may be not disposed coplanarly in other embodiments. The first touch-sensing units 5180 can be made of transparent material or opaque material. When the first touch-sensing units 5180 are made of opaque material, they can be disposed corresponding to a light-blocking layer, which is a black matrix (BM) layer of the color filter substrate 511 for example. Further, the first touch-sensing layer 518 with the first touch-sensing units 5180 thereof can act as a light-blocking layer. Besides, an overcoat layer 5113 can be disposed on the transparent substrate 5111 to cover the first touch-sensing units 5180.

In this embodiment, the second touch-sensing layer 515 comprises a plurality of second touch-sensing units 5150 disposed on the color filter substrate 511. In other embodiments, there may be a plurality of second touch-sensing layers 515 disposed on the color filter substrate 511. Herein, the description of the second touch-sensing units 5150, the first interval region 5151 formed between the adjacent second touch-sensing units 5150 and the first anti-interference spot 516 can refer to the description of the touch-sensing units 215, the first interval region 2151 formed between the adjacent touch-sensing units 215 and the first anti-interference spot 216 in paragraphs [0058], [0059] and [0060], so the related description is omitted here for conciseness.

FIG. 14 is a schematic diagram of the anti-interference touch display panel 51a of another embodiment of the invention. As shown in FIG. 14, the main difference between the anti-interference touch display panels 51 and 51a is that the first anti-interference spot 516a of the anti-interference touch display panel 51a not only is disposed in the first interval region 5151 but also covers at least a part of the second touch-sensing units 5150, and is filled into the first interval region 5151. Herein, the first anti-interference spot 516a is made of insulating material such that the second touch-sensing units 5150 won't be short-circuited. The first anti-interference spot 516a can be made of transparent material so as to be pervious to the light.

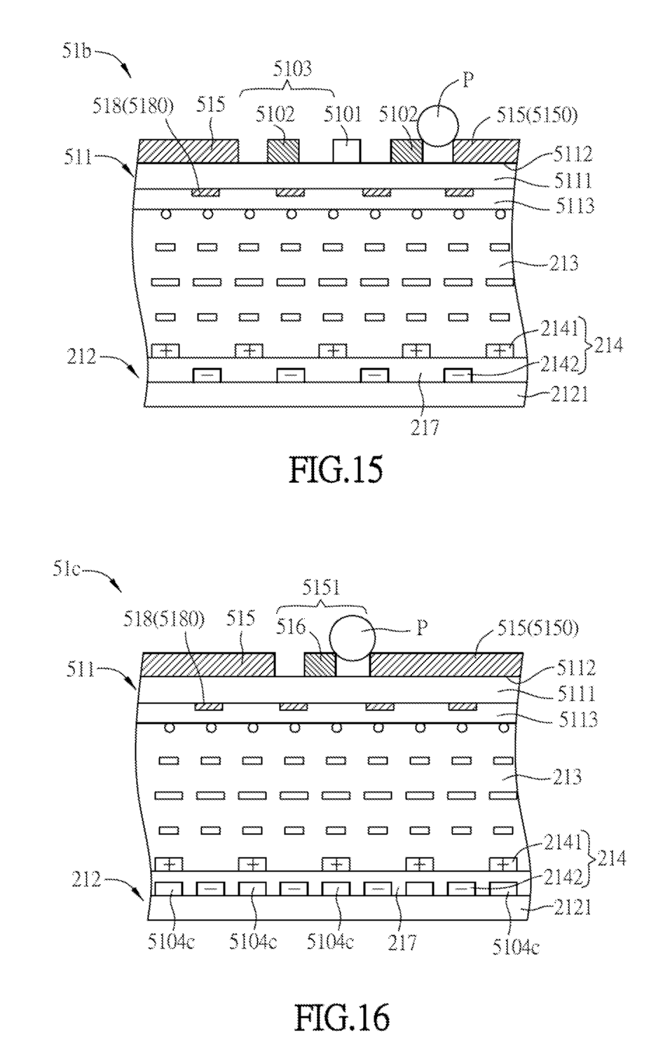

FIG. 15 is a schematic diagram of the anti-interference touch display panel 51b of another embodiment of the invention. As shown in FIG. 15, the main difference between the anti-interference touch display panels 51 and 51b is that the anti-interference touch display panel 51b further comprises a grounding unit 5101 and at least a second anti-interference spot 5102. The grounding unit 5101 is disposed coplanarly with the first or second touch-sensing units (the second touch-sensing units 5150 for example, herein), and the grounding unit 5101 and the adjacent first or second touch-sensing unit have a second interval region 5103 therebetween. Besides, the second anti-interference spot 5102 is disposed within the second interval region 5103. Herein, the description of the second touch-sensing units 5150, the grounding unit 5101, the second interval region 5103 and the second anti-interference spot 5102 can refer to the description of the touch-sensing units 215, the grounding unit 2101, the second interval region 2103 and the second anti-interference spot 2102 in paragraph [0062], so the related description is omitted here for conciseness.

FIG. 16 is a schematic diagram of the anti-interference touch display panel 51c of another embodiment of the invention. As shown in FIG. 16, the anti-interference touch display panel 51c can further comprise at least another touch-sensing unit 5104c, and the touch-sensing unit 5104c can be coplanarly disposed with the common electrode 2142 or the pixel electrode 2141, or can be disposed above or below the common electrode 2142 or the pixel electrode 2141. Herein, the touch-sensing unit 5104c is coplanarly disposed with the common electrode 2142 for example. Therefore, a capacitance can be formed between the touch-sensing unit 5104c and the common electrode 2142, and the touch sensing can be implemented according to the capacitance change caused by the user's touch.

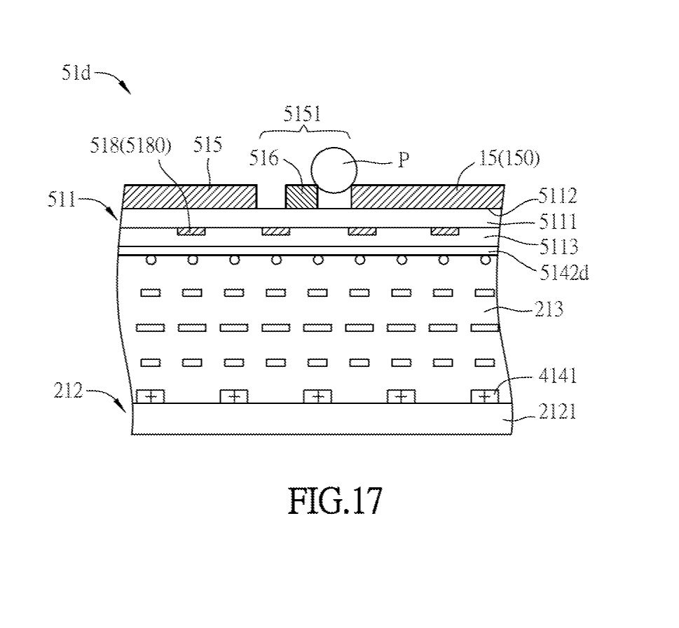

FIG. 17 is a schematic diagram of the anti-interference touch display panel 51d of another embodiment of the invention. As shown in FIG. 17, the main difference between the anti-interference touch display panels 51 and 51d is that the anti-interference touch display panel 51d is not a FFS display panel, and the common electrode 5142d thereof is disposed on the side of the overcoat layer 5113 closer to the display functional layer 213, so that the liquid crystal of the display functional layer 213 can be driven by the electric field formed by the common electrode 5142d and the pixel electrode 4141.

The touch-sensing units of the anti-interference touch display panel of this invention can have multiple variations, some of which can refer to FIGS. 11, 12A˜12D and paragraphs [0081]˜[0083].

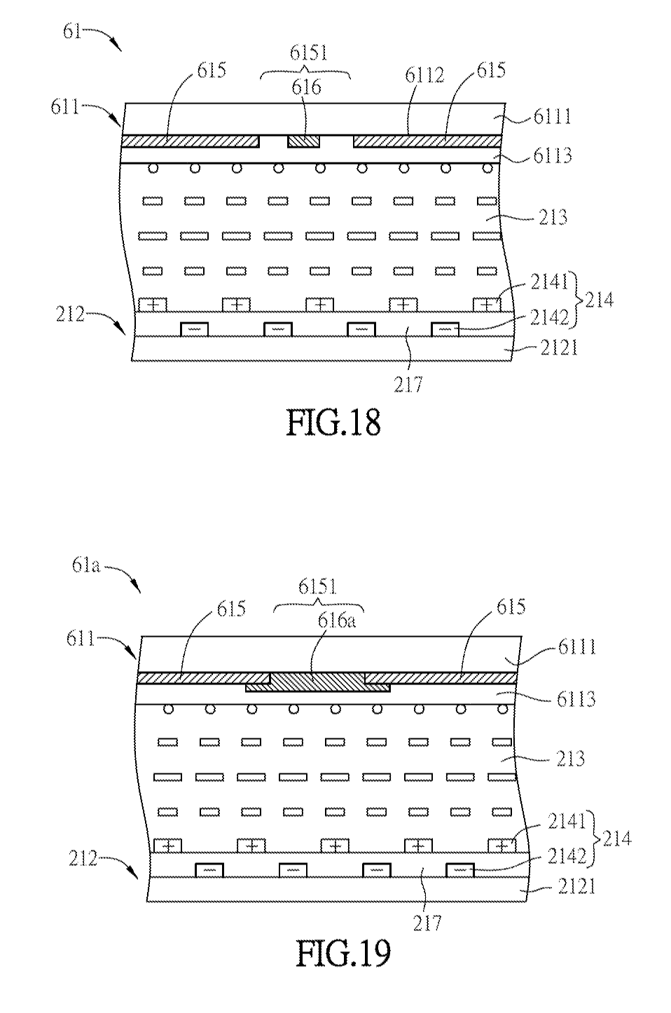

FIG. 18 is a schematic diagram of the anti-interference touch display panel 61 of an embodiment of the invention. As shown in FIG. 18, the anti-interference touch display panel 61 comprises a color filter substrate 611, an active matrix transistor substrate 212, a display functional layer 213, an electrode pair 214, a plurality of touch-sensing units 615 and at least one anti-interference spot 616. The anti-interference touch display panel 61 of this embodiment can be, for example, a TN (twisted nematic), VA (vertical alignment), IPS (in-plane switching) or FFS liquid crystal touch display panel, or an organic light-emitting touch display panel. Herein, the anti-interference touch display panel 61 is illustrated as a FFS liquid crystal touch display panel for example.

The color filter substrate 611 comprises a transparent substrate 6111, and can further comprise a color filter layer, or a black matrix layer, or an alignment layer, or a polarizing layer or other functional layers. Since the conventional art can be applied to the above-mentioned elements, the related illustrations are omitted here for conciseness. Moreover, the structure of the above-mentioned color filter substrate 611 is just for example but not for limiting the scope of the invention. In addition, because the FFS technology is used in this embodiment, the common electrode is disposed on the active matrix transistor substrate 212.

The touch-sensing units 615 are coplanarly disposed between the transparent substrate 6111 of the color filter substrate 611 and the active matrix transistor substrate 212. Herein, the touch-sensing units 615 are disposed on the side of the color filter substrate 611 facing the display functional layer 213. The touch-sensing units 615 are disposed, for example, on a surface 6112 of the transparent substrate 6111 to achieve the coplanar disposition. A first interval region 6151 is formed between the adjacent touch-sensing units 615, and a first anti-interference spot 616 is disposed within the first interval region 6151. The touch-sensing units 615 can be made of transparent conducting materials, such as ITO or other metal oxides. The two touch-sensing units 615 shown in FIG. 18 are electrically insulated from each other for example. Besides, an overcoat layer 6113 can be disposed on the transparent substrate 6111 to cover the touch-sensing unit 615 and the first anti-interference spot 616.

Herein, the material and the forming method of the touch-sensing units 615 and the first anti-interference spot 616 can refer to the description of the touch-sensing units 215 and the first anti-interference spot 216 in paragraphs [0059] and [0060], so the related description is omitted here for conciseness. By disposing the first anti-interference spot 616 within the first interval region 6151, the interval between the adjacent touch-sensing units 615 (first interval region 6151) can be enlarged. Therefore, even if the particles P fall down or the scratch occurs, the adjacent touch-sensing units 615 won't be short-circuited, so as to prevent the malfunction of the touch product and enhance the product yield.

FIG. 19 is a schematic diagram of the anti-interference touch display panel 61a of another embodiment of the invention. As shown in FIG. 19, the main difference between the anti-interference touch display panels 61 and 61a is that the first anti-interference spot 616a of the anti-interference touch display panel 61a not only is disposed in the first interval region 6151 but also covers at least a part of the touch-sensing units 615, and is filled into the first interval region 6151. Herein, the first anti-interference spot 616a is made of insulating material such that the touch-sensing units 615 won't be short-circuited. The first anti-interference spot 616a can be made of transparent material so as to be pervious to the light.

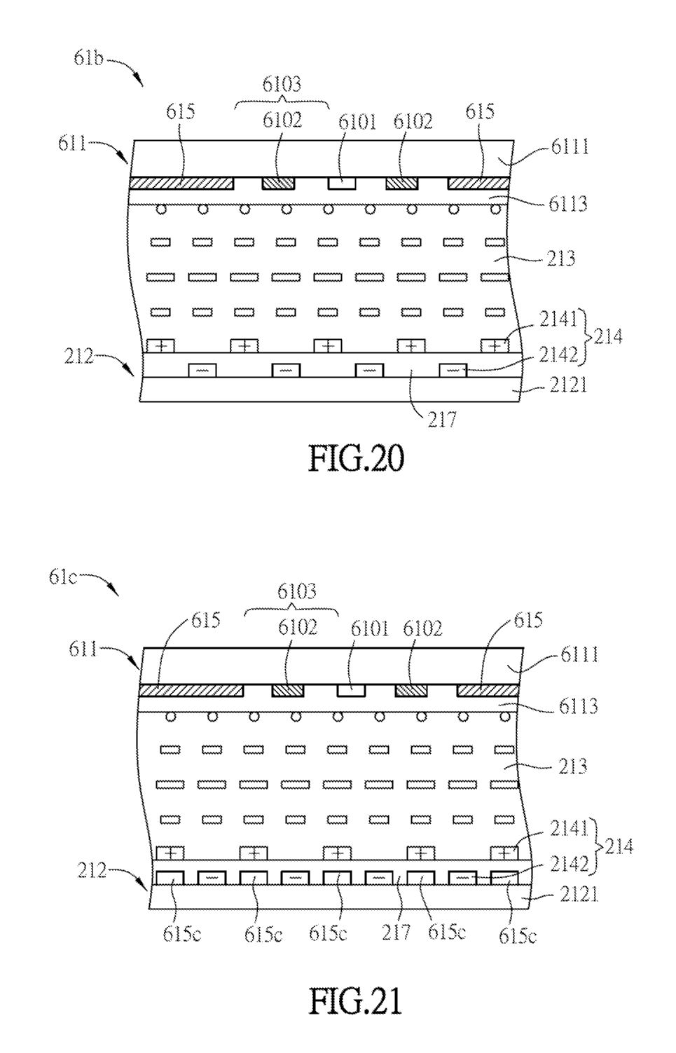

FIG. 20 is a schematic diagram of the anti-interference touch display panel 61b of another embodiment of the invention. As shown in FIG. 20, the main difference between the anti-interference touch display panels 61 and 61b is that the anti-interference touch display panel 61b further comprises a grounding unit 6101 and at least a second anti-interference spot 6102. The grounding unit 6101 is disposed coplanarly with the touch-sensing units 615, and the grounding unit 6101 and the adjacent touch-sensing unit 615 have a second interval region 6103 therebetween. Besides, the second anti-interference spot 6102 is disposed within the second interval region 6103. Herein, the material and the forming method of the touch-sensing units 615 and the second anti-interference spot 6102 can refer to the description of the touch-sensing units 215 and the second anti-interference spot 2102 in paragraph [0062], so the related description is omitted here for conciseness. By disposing the second anti-interference spot 6102 within the second interval region 6103, the interval between the touch-sensing unit 615 and the grounding unit 6101 (second interval region 6103) can be enlarged. Therefore, even if the particles fall down or the scratch occurs, the touch-sensing unit 615 and the adjacent grounding unit 6101 won't be short-circuited, so as to prevent the malfunction of the touch product and enhance the product yield.

FIG. 21 is a schematic diagram of the anti-interference touch display panel 61c of another embodiment of the invention. As shown in FIG. 21, the anti-interference touch display panel 61c can further comprise at least another touch-sensing unit 615c, and the touch-sensing unit 615c can be coplanarly disposed with the common electrode 2142 or the pixel electrode 2141, or can be disposed above or below the common electrode 2142 or the pixel electrode 2141. Herein, the touch-sensing unit 615c is coplanarly disposed with the common electrode 2142 for example. Therefore, a capacitance can be formed between the touch-sensing unit 615c and the common electrode 6142, and the touch sensing can be implemented according to the capacitance change caused by the user's touch.

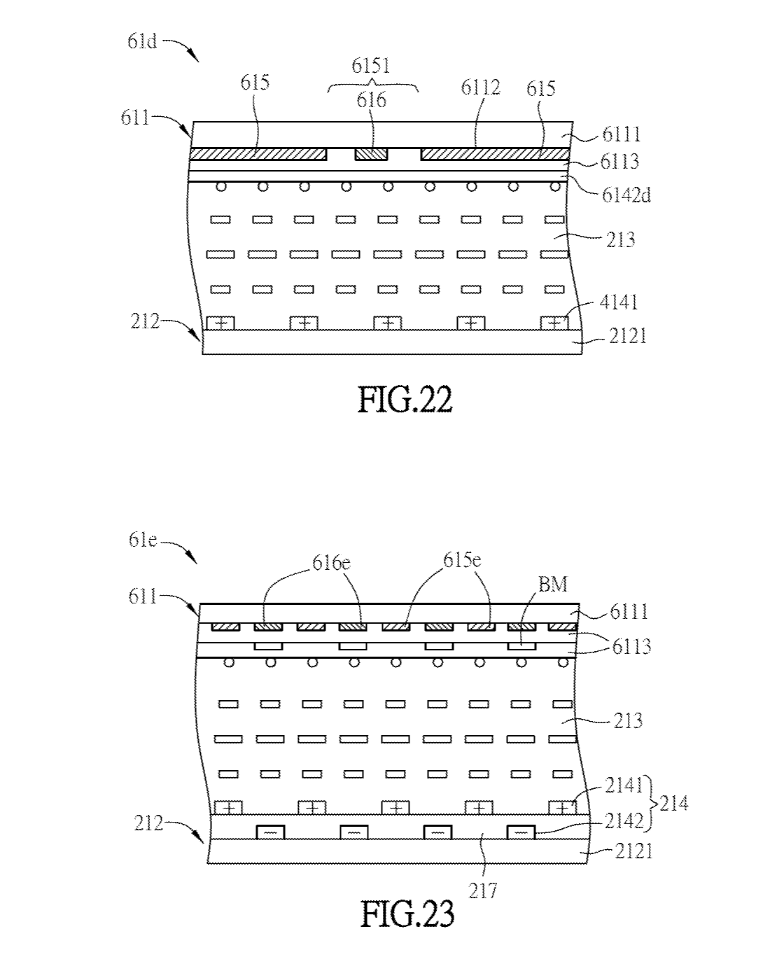

FIG. 22 is a schematic diagram of the anti-interference touch display panel 61d of another embodiment of the invention. As shown in FIG. 22, the main difference between the anti-interference touch display panels 61 and 61d is that the anti-interference touch display panel 61d is not a FFS display panel, and the common electrode 6142d thereof is disposed on the color filter substrate 611, for example, on the side of the transparent substrate 6111 facing the display functional layer 213, so that the liquid crystal of the display functional layer 213 can be driven by the electric field formed by the common electrode 6142d and the pixel electrode 4141.

FIG. 23 is a schematic diagram of the anti-interference touch display panel 61e of another embodiment of the invention. As shown in FIG. 23, the color filter substrate 611 of the anti-interference touch display panel 61e further comprises a light-blocking layer BM, and the first anti-interference spot 616e is disposed corresponding to the light-blocking layer BM. Herein, the light-blocking layer BM overlaps the first anti-interference spot 616e. Thereby, the light-blocking layer BM can not only define the position of the pixel but also block the light passing through the first anti-interference spot 616e, so as to enhance the display performance. Besides, the light-blocking layer BM also can be disposed corresponding to the touch-sensing unit 615e or corresponding to the touch-sensing unit 615e and the first anti-interference spot 616e. In addition, the color filter substrate 611 further comprises an overcoat layer 6113 covering the light-blocking layer BM.

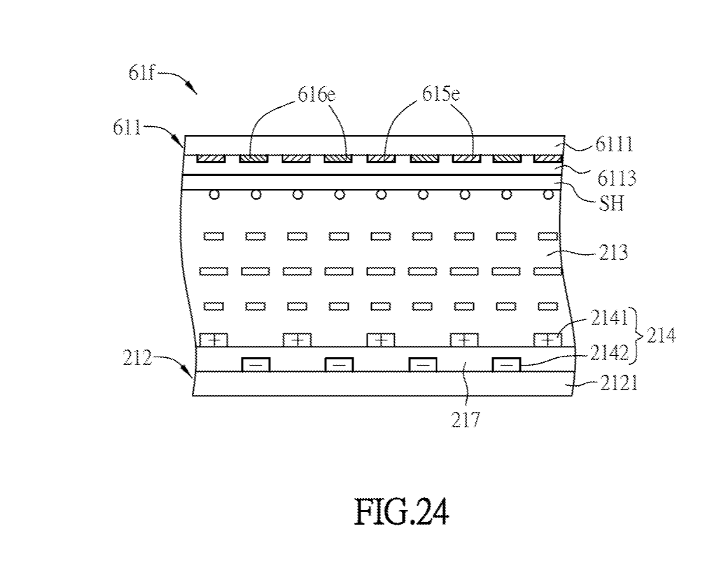

FIG. 24 is a schematic diagram of the anti-interference touch display panel 61f of another embodiment of the invention. The anti-interference touch display panel 61f further comprises a shielding layer SH, which is disposed between the touch-sensing units 615e and the display functional layer 613 to prevent the electric field within the liquid crystal layer from affecting the touch-sensing units 615e. Because the light-blocking layer has a mesh structure, the light-blocking layer can be used to shield the electric field when formed with a proper density. Therefore, the above-mentioned shielding layer SH also can be replaced by the light-blocking layer (BM) or both of them can exist together. Moreover, the overcoat layer 613 is an insulating layer to avoid the electrical connection between the shielding layer SH and the touch-sensing units 615e. In addition, the overcoat layer 613 also can be replaced by an insulating layer.

The touch-sensing units of the anti-interference touch display panel of this invention can refer to FIGS. 11, 12A˜12D and paragraphs [0081]˜[0083].

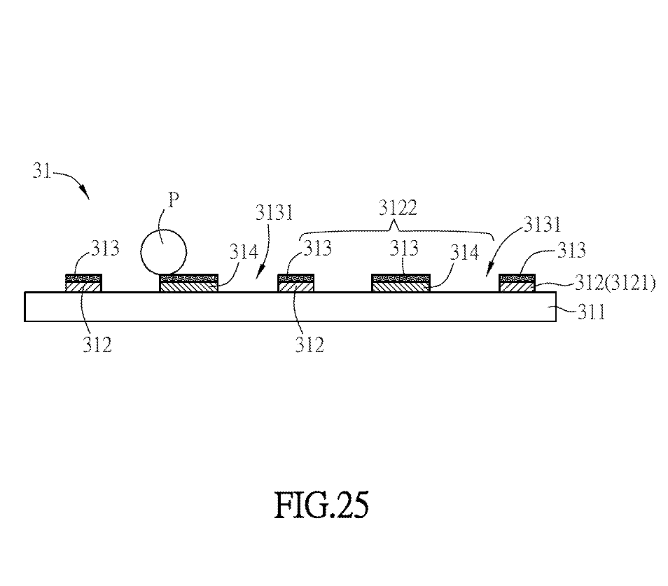

FIG. 25 is a schematic sectional diagram of an anti-interference touch-sensing stack 31 of an embodiment of the invention. As shown in FIG. 25, the anti-interference touch-sensing stack 31 comprises a plurality of metal mesh sensing unit 312, a light-blocking array layer 313 and at least one first anti-interference spot 314, and the anti-interference touch-sensing stack 31 is disposed on a transparent substrate 311.

The transparent substrate 311 is, for example, a glass substrate, a plastic substrate or another substrate made of other materials. Herein, the transparent substrate 311 is a glass substrate for example. The transparent substrate 311 can be a rigid substrate or a flexible substrate. When being a flexible substrate, the transparent substrate 311 can be applied to a flexible display device. In application, the transparent substrate 311 can be a cover glass to decrease the thickness of the applied display panel. An edge of the cover glass can be a curved surface to enhance the 3D display effect. The transparent substrate 311 is, for example, a substrate of the color filter substrate.

The metal mesh sensing units 312 (i.e. the touch-sensing units of this invention) comprise a plurality of metal wires 3121. The metal wires 3121 are coplanarly disposed on the transparent substrate 311 and a first interval region 3122 is formed between the adjacent metal wires 3121. The metal wires 3121 are the metal-made touch-sensing wires, so that they can reduce the signal attenuation problem occurring in the design of a large-size ITO by their own conducting property of the metal material. Besides, the metal material has better flexibility than ITO so that it can be applied to a flexible touch panel.

The light-blocking array layer 313 is disposed on the metal mesh sensing units 312 and correspondingly covers the metal wires 3121. The light-blocking array layer has at least one opening 3131. The light-blocking array layer 313 is, for example, a black matrix (BM) layer. The light-blocking array layer 313 can be combined with the black matrix layer of the applied display panel, or at least a part of the black matrix layer acts as the light-blocking array layer 313. The light-blocking array layer 313 can absorb the light in the region of the metal wires 3121, so as to enhance the display performance. Moreover, the light-blocking array layer 313 also can be disposed as overlapping the first anti-interference spots 314, and for example, disposed on the first anti-interference spots 314.

The first anti-interference spot 314 is disposed within the first interval region 3122. In practice, the first anti-interference spot 314 and the metal wires 3121 can be formed in the same processing step and made of the same material to reduce the processing steps. However, this invention is not limited thereto. Herein, the first anti-interference spot 314 is made of conducting materials and is electrically floating, and a distance exists between the first anti-interference spot 314 and the adjacent metal wire 3121. By disposing the first anti-interference spot 314 within the first interval region 312, the interval between the adjacent metal wires 3121 (first interval region 3122) can be enlarged. Therefore, even if the particles P fall down or the scratch occurs, the adjacent metal wires 3121 won't be short-circuited, so as to prevent the malfunction of the touch product and enhance the product yield. The width of the first anti-interference spot 314 is, for example, between 50 μm and 70 μm, and the width of the first interval region 3122 is, for example, between 70 μm and 130 μm. In one embodiment, the material of the first anti-interference spot 314 can comprise metal oxide. Moreover, the first anti-interference spots 314 can comprise a massive spot or a bent spot.

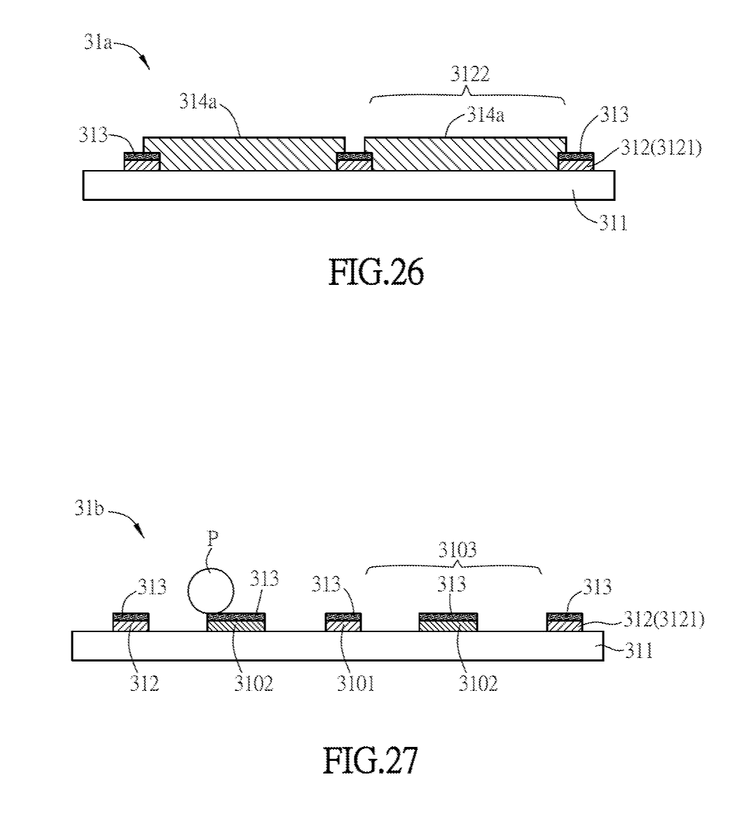

FIG. 26 is a schematic diagram of the anti-interference touch-sensing stack 31a of another embodiment of the invention. As shown in FIG. 26, the main difference between the anti-interference touch-sensing stacks 31 and 31a is that the first anti-interference spot 314a of the anti-interference touch-sensing stack 31a not only is disposed in the first interval region 3122 but also covers at least a part of the metal wires 3121, and is filled into the first interval region 3122. Herein, the first anti-interference spot 314a is made of insulating material such that the metal wires 3121 won't be short-circuited. The first anti-interference spot 314a can be made of transparent material so as to be pervious to the light.

FIG. 27 is a schematic diagram of the anti-interference touch-sensing stack 31b of another embodiment of the invention. As shown in FIG. 27, the main difference between the anti-interference touch-sensing stacks 31 and 31b is that the anti-interference touch-sensing stack 31b further comprises a grounding unit 3101 and at least a second anti-interference spot 3102. The grounding unit 3101 is disposed coplanarly with the metal wires 3121, and the grounding unit 3101 and the adjacent metal wire 3121 have a second interval region 3103 therebetween. Besides, the second anti-interference spot 3102 is disposed within the second interval region 3103. Likewise, in practice, the second anti-interference spot 3102 and the metal wires 3121 can be made in the same processing step and made of the same material to reduce the processing steps. However, this invention is not limited thereto. Herein, the second anti-interference spot 3102 is made of conducting materials and is electrically floating. By disposing the second anti-interference spot 3102 within the second interval region 3103, the interval between the metal wire 3121 and the grounding unit 3101 (second interval region 3103) can be enlarged. Therefore, even if the particles P fall down or the scratch occurs, the metal wire 3121 and the adjacent grounding unit 3101 won't be short-circuited, so as to prevent the malfunction of the touch product and enhance the product yield. For example, the width of the second anti-interference spot 3102 is between 50μm and 70 μm, and the width of the second interval region 3103 is between 70μm and 130 μm.

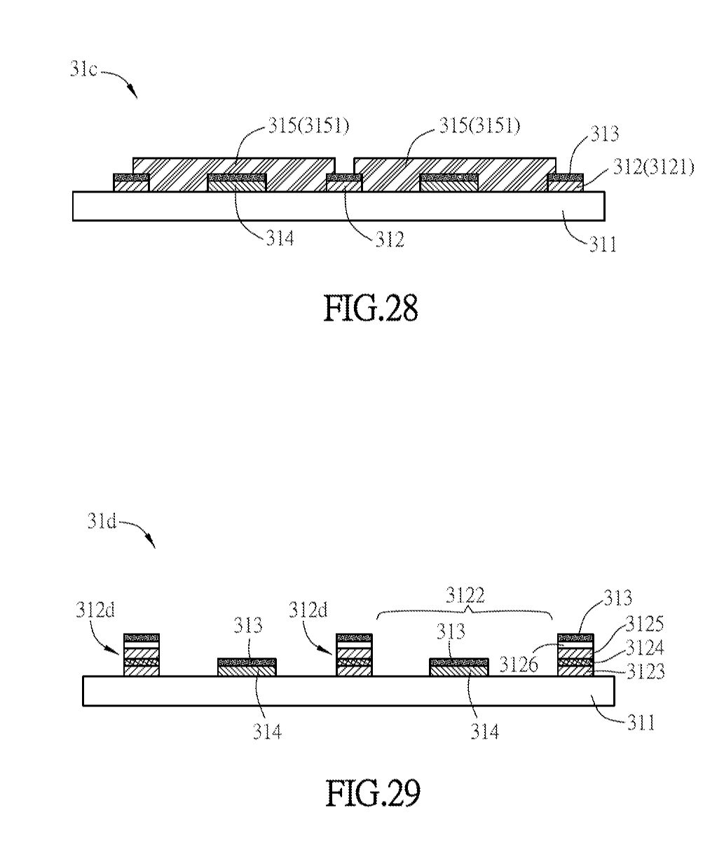

FIG. 28 is a schematic diagram of the anti-interference touch-sensing stack 31c of another embodiment of the invention. As shown in FIG. 28, the main difference between the anti-interference touch-sensing stacks 31 and 31c is that the anti-interference touch-sensing stack 31c further comprises a color filter layer 315. The color filter layer 315 comprises a plurality of filter bodies 3151 correspondingly disposed in the openings 3131 (referring to FIG. 25), and each of the filter bodies 3151 partially covers the light-blocking array layer 313. By the disposition of the color filter layer 315, the anti-interference touch-sensing stack 31c of this embodiment can be applied to a color display panel.

FIG. 29 is a schematic diagram of the anti-interference touch-sensing stack 31d of another embodiment of the invention. As shown in FIG. 29, the main difference between the anti-interference touch-sensing stacks 31 and 31d is that the metal mesh sensing units 312d of the anti-interference touch-sensing stack 31d comprise first metal mesh sensing sub-units 3123, an insulating layer 3124 and second metal mesh sensing sub-units 3125. The first metal mesh sensing sub-units 3123 are disposed on the transparent substrate 311 and comprise a plurality of metal wires. The insulating layer 3124 is disposed on the first metal mesh sensing sub-units 3123. The second metal mesh sensing sub-units 3125 are disposed on the insulating layer 3124 and comprise a plurality of metal wires. Moreover, the second metal mesh sensing sub-units 3125 match the first metal mesh sensing sub-units 3123 in shape and cover the first metal mesh sensing sub-units 3123. The insulating layer 3124 matches the first metal mesh sensing sub-units 3123 and the second metal mesh sensing sub-units 3125 in shape. The insulating layer 3124 and the light-blocking array layer can be made of the same material. The light-blocking array layer 313 matches the first metal mesh sensing sub-units 3125 and the second metal mesh sensing sub-units 3123 in shape and covers the first metal mesh sensing sub-units 3125 and the second metal mesh sensing sub-units 3123. Moreover, the light-blocking array layer 313 adheres to the second metal mesh sensing sub-units 3125 through an adhering layer 3126.

In this embodiment, the insulating layer 3124 possesses the anti-glare ability. In one embodiment, the manufacturing method of the insulating layer 3124 comprises the following steps of: forming a plurality of electrodes (i.e. the metal wires of the metal mesh sensing unit for example) on the substrate; coating the substrate having the electrodes with a non-optical-rotation-sensitive anti-glare polyimide precursor layer; implementing a first prebake to the substrate coated with the anti-glare polyimide precursor layer; forming a photoresist layer on the anti-glare polyimide precursor layer by coating; implementing a second prebake to the substrate coated with the anti-glare polyimide precursor layer and the photoresist layer; implementing an exposure by photomask; implementing a development to the photoresist material to form the patterned photoresist layer; etching the anti-glare polyimide precursor layer to form the patterned anti-glare polyimide precursor layer; stripping the photoresist layer; and baking the substrate having the anti-glare polyimide precursor layer to cross-link and harden the anti-glare polyimide so as to form the patterned anti-glare polyimide insulating layer. Since the polyimide has better thermal stability, mechanical stability, electrical stability and optical stability, the applied display panel also can have better stability with a longer lifespan.

To be noted, the technical features of the above embodiments can be implemented separately or in combination, or can be applied to other embodiments, according to the requirements.

Summarily, in the anti-interference touch display panel of this invention, the first anti-interference spot is disposed in the first interval region formed by the adjacent touch-sensing units, and the interval between the touch-sensing units is enlarged thereby, for example, to 70 μm˜130 μm from the original 10 μm˜30 μm. Hence, even if the particles fall down or the scratch occurs during the process, the adjacent touch-sensing units won't be short-circuited. Therefore, the first anti-interference spots provide the electrical anti-interference effect, so as to prevent the malfunction of the touch product and enhance the product yield and flexibility.

Furthermore, the enlarged spacing between the touch-sensing units may make the human eyes perceive the existence of the touch-sensing units, but because the first anti-interference spot with a zigzag pattern is disposed between the adjacent touch-sensing units, the touch-sensing units will become invisible and the human eyes will not easily perceive their existence, so as to provide the optical anti-interference effect and enhance the display performance.

Besides, because the pixel electrode and the data lines are disposed on the gate insulating layer in this invention, the pixel electrode can directly contact the drain instead of through the via for electrically connecting to the drain, and the pixel aperture ratio can be increased thereby. Furthermore, in the design of the common electrode of this invention, the consideration needn't be given to the interval between the common electrode and the gate line, so that the pixel aperture ratio won't be sacrificed.

Furthermore, the first anti-interference spots and/or the touch-sensing units are disposed corresponding to the light-blocking array layer (or the light-blocking layer), and for example, the light-blocking array layer is disposed corresponding to the first anti-interference spots. Thereby, the light-blocking array layer can not only define the position of the pixel but also block the light passing through the first anti-interference spots, so as to enhance the display performance.

In addition, this invention also discloses the replacement or sharing of some layers of the anti-interference touch display panel for the touch-sensing units. For example, the first conducting wire can act as the light-blocking layer or the first touch-sensing layer acts as the light-blocking layer. Thereby, the anti-interference touch display panel can be given the effects of decreasing the cost and the thickness.

Moreover, the shielding layer is disposed between the touch-sensing units and the display functional layer (e.g. liquid crystal layer) to prevent the electric field within the liquid crystal layer from affecting the touch-sensing units.

Besides, because the light-blocking array layer matches the metal mesh sensing units in shape and covers the metal mesh sensing units in this invention, the Moire phenomenon can be reduced.

In addition, the insulating layer of this invention possesses the anti-glare ability so that is can absorb and filter the external incident light. Thereby, the reflection and interference generated between the external incident light and the metal mesh can be reduced, the brightness contrast of the display panel can be enhanced, and the anti-glare effect can be provided against the external incident light.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An anti-interference touch display panel, comprising:
a color filter substrate;
an active matrix transistor substrate disposed corresponding to the color filter substrate;
a display functional layer disposed between the color filter substrate and the active matrix transistor substrate;
a plurality of touch-sensing units coplanarly disposed on the color filter substrate, wherein a first interval region is formed between the adjacent-touch sensing units; and
at least one first anti-interference spot disposed within the first interval region.

2. The anti-interference touch display panel as recited in claim 1, further comprising:
a grounding unit disposed coplanarly with the touch-sensing units, wherein the grounding unit and the adjacent touch-sensing unit have a second interval region therebetween; and
at least a second anti-interference spot disposed within the second interval region.

3. The anti-interference touch display panel as recited in claim 1, wherein the anti-interference touch display panel is a fringe field switching (FFS) liquid crystal touch display panel, the display functional layer is a liquid crystal layer, and the anti-interference touch display panel further comprises:
a pixel electrode and a common electrode disposed on the active matrix transistor substrate, wherein the rotation of the liquid crystal molecules of the liquid crystal layer is controlled by the fringe field generated between the pixel electrode and the common electrode.

4. The anti-interference touch display panel as recited in claim 3, wherein the active matrix transistor substrate comprises:
a transparent substrate;
a plurality of gate lines disposed on the transparent substrate;
a gate insulating layer disposed on the transparent substrate and covering the gate lines; and
a plurality of data lines disposed on the gate insulating layer, wherein the pixel electrode is disposed on the gate insulating layer and located on the same layer as the data lines.

5. The anti-interference touch display panel as recited in claim 3, wherein the active matrix transistor substrate comprises:
a transparent substrate;
a plurality of gate lines disposed on the transparent substrate, wherein the common electrode is disposed on the transparent substrate and located on the same layer as the gate lines;
a gate insulating layer disposed on the transparent substrate and covering the gate lines and the common electrode; and
a plurality of data lines disposed on the gate insulating layer, wherein the pixel electrode is disposed on the gate insulating layer.

6. The anti-interference touch display panel as recited in claim 3, further comprising:
at least another touch-sensing unit disposed coplanarly with the common electrode or the pixel electrode.

7. The anti-interference touch display panel as recited in claim 3, wherein the common electrode is a single-piece electrode, and the pixel electrode has a slit pattern formed therein and is disposed over the common electrode, or the pixel electrode is a single-piece electrode, and the common electrode has a slit pattern formed therein and is disposed over the pixel electrode.

8. The anti-interference touch display panel as recited in claim 3, wherein the common electrode comprises multiple strip-like electrodes separated from each other, and the pixel electrode comprises multiple electrodes separated from each other and disposed over the portion between the adjacent strip-like electrodes of the common electrode, or the pixel electrode comprises multiple strip-like electrodes separated from each other, and the common electrode comprises multiple electrodes separated from each other and disposed over the portion between the adjacent strip-like electrodes of the pixel electrode.

9. The anti-interference touch display panel as recited in claim 1, wherein the touch-sensing units are coplanarly disposed on the color filter substrate.

10. The anti-interference touch display panel as recited in claim 9, further comprising:
a polarizing layer and/or a protection glass disposed on the color filter substrate, wherein the touch-sensing units are disposed on the polarizing layer and/or the protection glass.

11. The anti-interference touch display panel as recited in claim 9, wherein the color filter substrate comprises a light-blocking array layer, and the first anti-interference spot and/or the touch-sensing units are disposed corresponding to the light-blocking array layer.

12. The anti-interference touch display panel as recited in claim 1, wherein the color filter substrate comprises a transparent substrate, the touch-sensing units are second touch-sensing units, and the anti-interference touch display panel further comprises:
a first touch-sensing layer comprising a plurality of first touch-sensing units disposed between the transparent substrate of the color filter substrate and the display functional layer; and
at least one second touch-sensing layer comprising the second touch-sensing units disposed on the color filter substrate.

13. The anti-interference touch display panel as recited in claim 12, further comprising:
a grounding unit disposed coplanarly with the first or second touch-sensing units, wherein the grounding unit and the adjacent first or second touch-sensing unit have a second interval region therebetween; and
at least a second anti-interference spot disposed within the second interval region.

14. The anti-interference touch display panel as recited in claim 12, wherein the first touch-sensing layer acts as a light-blocking layer.

15. The anti-interference touch display panel as recited in claim 12, wherein the color filter substrate comprises a light-blocking layer and the first anti-interference spot is disposed corresponding to the light-blocking layer.

16. The anti-interference touch display panel as recited in claim 1, wherein the color filter substrate comprises a transparent substrate, and the touch-sensing units are coplanarly disposed between the transparent substrate of the color filter substrate and the active matrix transistor substrate.

17. The anti-interference touch display panel as recited in claim 16, further comprising:
a shielding layer disposed between the touch-sensing units and the display functional layer.

18. The anti-interference touch display panel as recited in claim 1, wherein the touch-sensing units include a plurality of metal mesh sensing units comprising a plurality of metal wires, and the anti-interference touch display panel further comprises:
a light-blocking array layer disposed on the metal mesh sensing units and correspondingly covering the metal wires, wherein the light-blocking array layer has at least one opening.

19. The anti-interference touch display panel as recited in claim 18, wherein the metal mesh sensing units comprise:
a plurality of first metal mesh sensing sub-units disposed on the color filter substrate;
an insulating layer disposed on the first metal mesh sensing sub-units; and
a plurality of second metal mesh sensing sub-units disposed on the insulating layer.

20. The anti-interference touch display panel as recited in claim 19, wherein the insulating layer possesses the anti-glare ability.
